(19) United States
(12) Patent Application Publication
(10) Pub. No.: US 2016/0116633 A1
(43) Pub. Date: Apr. 28, 2016

(54) SYSTEM AND METHOD OF LOCATING UNDERGROUND UTILITY

(71) Applicant: Caterpillar Inc., Peoria, IL (US)

(72) Inventors: Paul R. Friend, Morton, IL (US); Kenneth L. Stratton, Dunlap, IL (US)

(73) Assignee: Caterpillar Inc., Peoria, IL (US)

(21) Appl. No.: 14/520,803

(22) Filed: Oct. 22, 2014

(51) Int. Cl. G01V 8/16; G02B 6/02

(52) U.S. Cl. CPC G01V 8/16; G02B 6/02076

(57) ABSTRACT

A system for locating an underground utility having a conduit is disclosed. The system includes a fiber optic cable coupled to the conduit. The fiber optic cable includes at least one core and a plurality of strain sensors distributed along a length of the at least one core. A processing device is disposed in selective communication with the fiber optic cable. The processing device is configured to receive signals from the plurality of strain sensors. A service station is communicably coupled to the processing device. The service station is configured to determine a shape of the fiber optic cable. Further, the service station is configured to determine a position of the conduit relative to a predefined reference frame fixed with the service station based on the shape of the fiber optic cable.

### TECHNICAL FIELD

The present disclosure relates to a system and a method for locating an underground utility having a conduit.

### BACKGROUND

In general, public utilities such as a telecommunication system, a sewage system, a gas supply system, a water supply system, and the like are disposed underground. The underground utilities include one or more conduits to carry fluent materials such as water, gas, sewage and the like. Further, based on applications, the conduits may also enclose one or more electric cables or telecommunication cables. Such buried utilities may require periodic maintenance and/or modifications. In such situations, determining an exact position of the various conduits may be difficult without digging or accessing the conduits via underground service tunnels. Further, various construction and/or excavation work may have to be carried out at a location above the buried conduits. In such cases, the conduits may be accidentally damaged if a precise location is not available with reference to the ground surface.

French Patent Number 2,727,239 (the '239 patent) discloses a system for locating a buried cable, especially a dielectric optical fiber cable or a conduit. The '239 patent discloses a cable having a tube made of a plastic material. The tube includes a plurality of optical fibers. The tube is further surrounded by a reinforcing tube made of a dielectric material including reinforcing fibers. The reinforcing tube may be further surrounded by an outer protective sheath made from a plastic material. The material of the sleeve includes a disusing substance, specifically a volatile substance that may release an odorous gas. The odorous gas may be recognized by a trained animal.

Fiber optic shape sensing is known in the art. For an example, a system for sensing fiber optic shape is disclosed in US Patent Publication Number 2013/0308138. The patent includes a fiber optic cable having one or more cores. An optical interrogation console generates reflection spectrum data indicative of a measurement of both an amplitude and a phase of a reflection for each core as a function of wavelength. A 3D shape reconstructor reconstructs a 3D shape of the optical fiber.

### SUMMARY OF THE DISCLOSURE

In one aspect of the present disclosure, a system for locating an underground utility having a conduit is provided. The system includes a fiber optic cable coupled to the conduit. The fiber optic cable includes at least one core and a plurality of strain sensors distributed along a length of the at least one core. The system further includes a processing device disposed in selective communication with the fiber optic cable. The processing device is configured to receive signals from the plurality of strain sensors. The system also includes a service station communicably coupled to the processing device. The service station is configured to determine a position of the conduit relative to a predefined reference frame fixed with the service station.

In another aspect of the present disclosure, a conduit for an underground utility is provided. The conduit includes a wall defining a passage therein. The wall includes a first end and a second end. The conduit also includes a fiber optic cable embedded within the wall. The fiber optic cable includes at least one core and a plurality of strain sensors distributed along a length of the at least one core. The conduit further includes a coupling member disposed adjacent to at least one of the first end and the second end. The coupling member is configured to detachably couple the conduit to another conduit disposed adjacent to the conduit.

In yet another aspect of the present disclosure, a method of locating an underground utility having a conduit is provided. The method includes communicating a processing device with a fiber optic cable. The processing device is configured to receive signals from the fiber optic cable. The method further includes receiving signals via the processing device from a plurality of strain sensors. The plurality of strain sensors is distributed along a length of at least one core of the fiber optic cable. The method further includes communicating a service station with the processing device. The method also includes determining a position of the conduit relative to a predefined reference frame fixed with the service station based on the signals received from the plurality of strain sensors.

Other features and aspects of this disclosure will be apparent from the following description and the accompanying drawings.

### BRIEF DESCRIPTION OF THE DRAWINGS

FIG. 1 is a block diagram for illustrating a system for locating an underground utility, according to an embodiment of the present disclosure;

FIG. 2 is a sectional perspective view of an exemplary fiber optic cable, according to an embodiment of the present disclosure;

FIG. 3 is a partial sectional view of a conduit having the fiber optic cable coupled therewith, according to an embodiment of the present disclosure;

FIG. 4 is a partial sectional view of a conduit having the fiber optic cable coupled therewith, according to another embodiment of the present disclosure;

FIG. 5 illustrates an output of the system showing a location of the underground utility, according to an embodiment of the present disclosure; and

FIG. 6 is a flowchart of a method for locating an underground utility, according to an embodiment of the present disclosure.

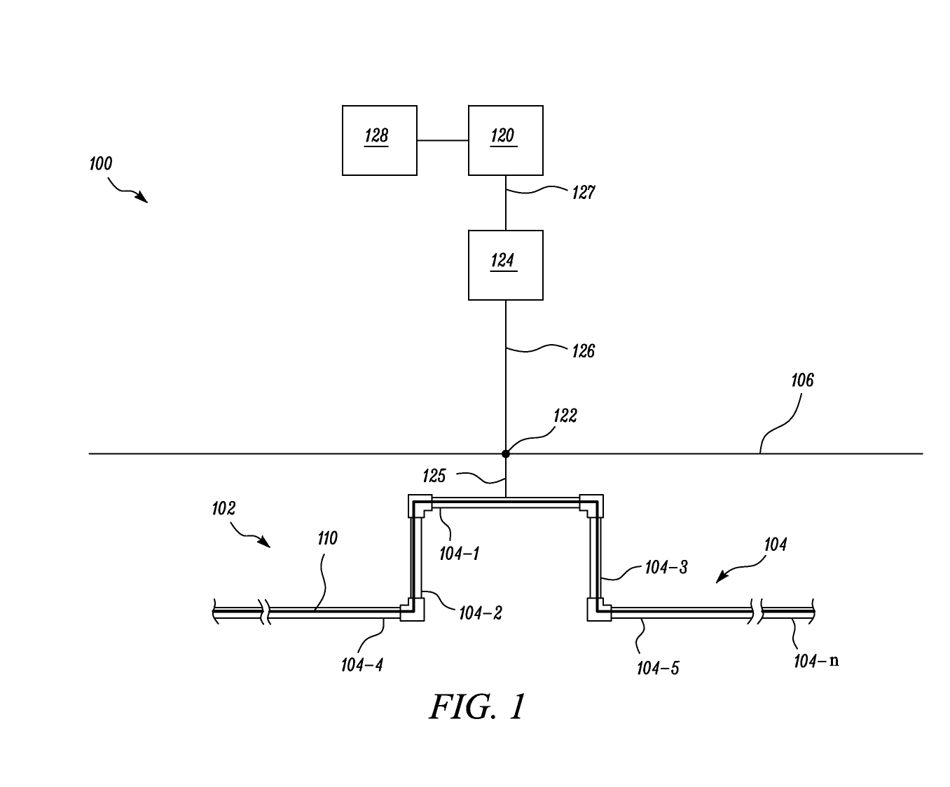

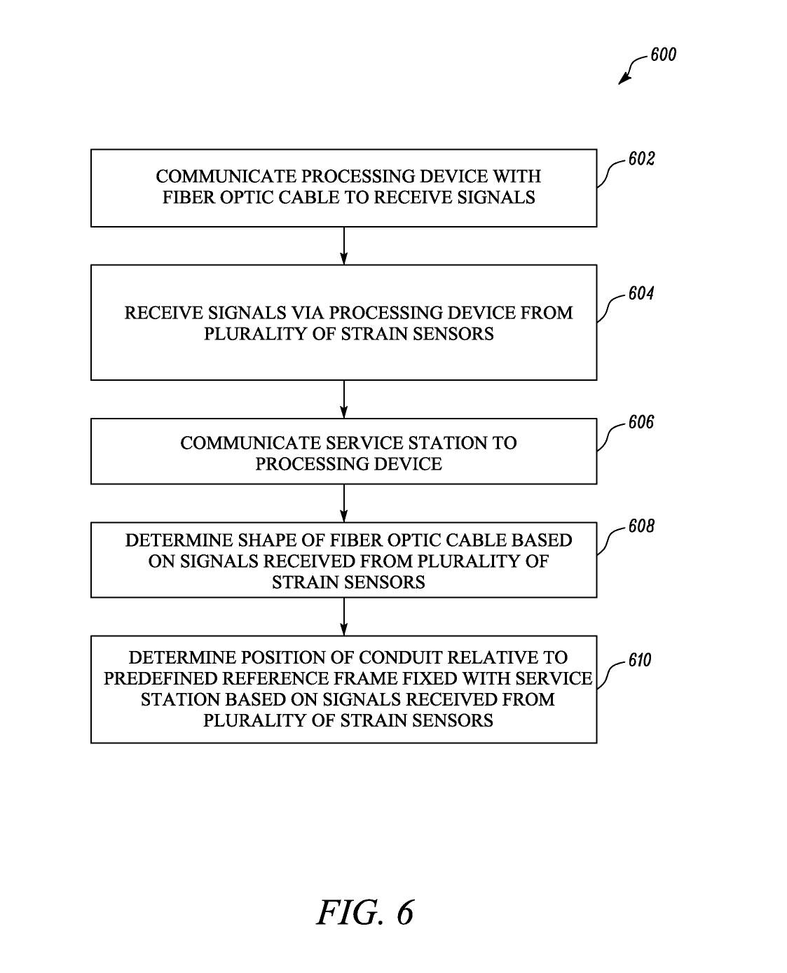

### DETAILED DESCRIPTION

Wherever possible, the same reference numbers will be used throughout the drawings to refer to the same or the like parts. FIG. 1 shows a block diagram for illustrating a system 100 for locating an underground utility 102, according to an embodiment of the present disclosure. The underground utility 102 may include a sewage system, a gas supply system, a water supply system, a telecommunication system, and the like.

The underground utility 102 may include one or more conduits 104 that may be buried under a ground 106. In the case of more than one conduit 104, each conduit 104 may be coupled with each other to form a conduit network. The conduits 104 may be configured to transport a fluent material, such as water, gas, sewage etc. Alternatively, the conduits 104 may enclose therein one or more cables which may be electricity cables, telecommunication cables, and the like. As shown in FIG. 1, the conduits 104 may be connected with one another serially. However, the conduit network may include one or more junctions (not shown) for connecting two or more conduits so as to form one or more branches of the conduit at one location. Further, the conduit network may include one or more service tunnels (not shown) accessible from above ground 106. In the embodiment of FIG. 1, the underground utility 102 may include more than one conduit 104 coupled each other to form an irregular shape instead of a straight conduit. Specifically, FIG. 1 shows a first conduit 104-1, a second conduit 104-2, a third conduit 104-3, . . . and an n^{th} conduit 104-n, which may be coupled each other to form the conduit network. The first conduit 104-1, the second conduit 104-2, the third conduit 104-3, . . . and the n^{th} conduit 104-n may be collectively or individually referred as a conduit 104 for purposes of description. Further, in the illustrated embodiment, the conduit 104 may be a pipe member. In various other embodiments, the conduit 104 may be a hose member, or any other conduit known in the art. The shape of the conduit network may depend on various factors, such as properties of the underground region, presence of other underground utilities, statutory regulations, presence of structures above the ground etc.

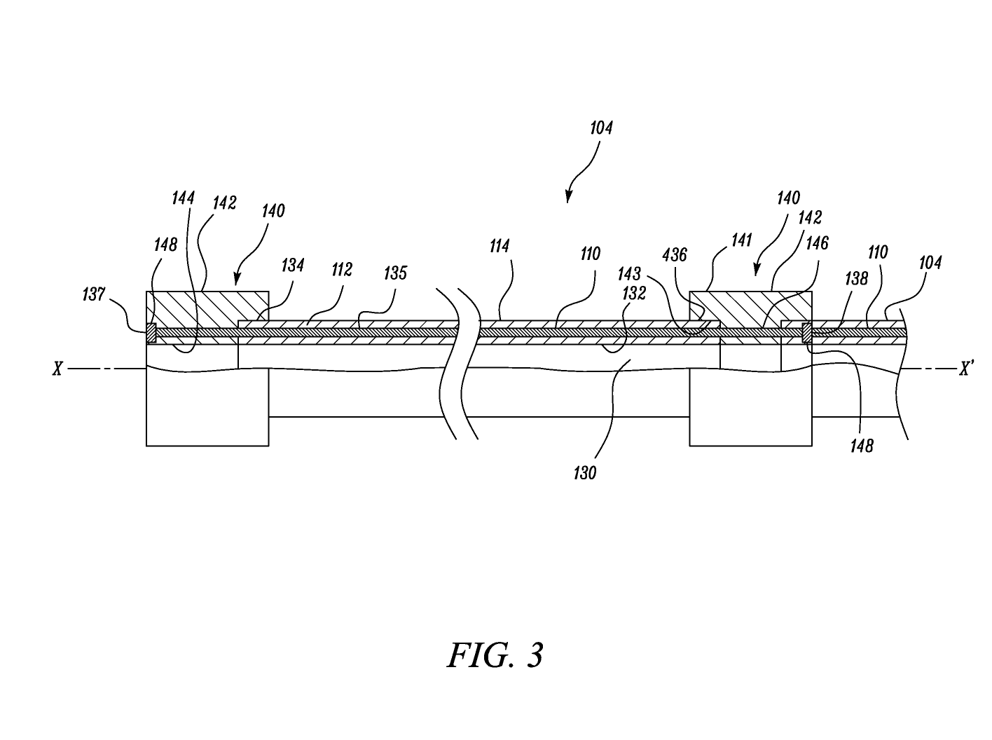

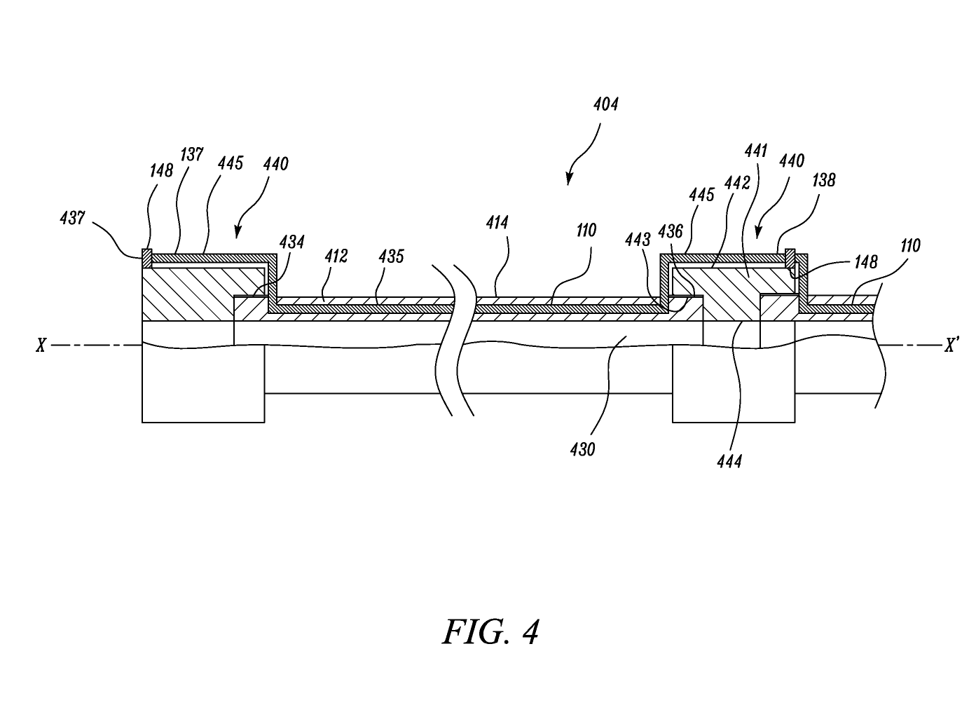

A fiber optic cable 110 may be coupled to each of the conduits 104. The fiber optic cable 110 may be coupled to the conduit 104 in various methods, as will be described later with reference to FIGS. 3 and 4. The fiber optic cable 110 of each of the conduits 104 may be coupled with respective adjacent fiber optic cable 110 for a continuous optical communication throughout a length of the conduit network.

The system 100 may further include a service port 122 communicably coupled to the fiber optic cable 110. The service port 122 may be accessible from above the ground 106. In an embodiment, the service port 122 may be configured to receive an end of the fiber optic cable 110 disposed in the conduit 104. In various other embodiments, the service port 122 may be coupled to any location of the fiber optic cable 110 throughout the length of the conduit 104. Specifically, the service port 122 may be coupled to the fiber optic cable 110 via a cable 125. The cable 125 may be configured to receive signals from the fiber optic cable 110. Alternatively, the cable 125 may be a fiber optic cable configured to be in continuous communication with the fiber optic cable 110 disposed in the conduit 104. In an embodiment, the cable 125 may be disposed in the tunnel formed from above the ground 106. The service port 122 may have a location above the ground 106 which may be vertically above an underground location to the conduit 104. Further, the service port 122 may be located in an enclosure (not shown). The enclosure may be configured to protect the service port 122 from environmental factors such as dust, moisture and the like.

The system 100 may further include a processing device 124. The processing device 124 may be configured to be in selective communication with the fiber optic cable 110. Further, the processing device 124 may be configured to be coupled to the service port 122. The processing device 124 may be connected to the service port 122 via a cable 126. The cable 126 may be detachably connected to the service port 122 and the processing device 124. Alternatively, the processing device 124 may be wirelessly connected to the service port 122. In an exemplary embodiment, the processing device 124 may include a microprocessor based controller. The processing device 124 may include, but not limited to, a transmitter and a receiver. The transmitter may be configured to convert an electrical signal into an optical signal and provide the optical signal as an output to the fiber optic cable 110 via the cable 126 and the service port 122. The transmitter may be a laser diode or a Light-Emitting Diode (LED). The receiver may be configured to receive the optical signal transmitted through the fiber optic cable 110 via the cable 126 and the service port 122. Further, the receiver may convert the optical signal into an electrical signal. The receiver may also include one or more signal converters, signal filters, signal amplifiers, and demodulators. The processing device 124 may optionally include a display module to display input and/or output signals to an operator.

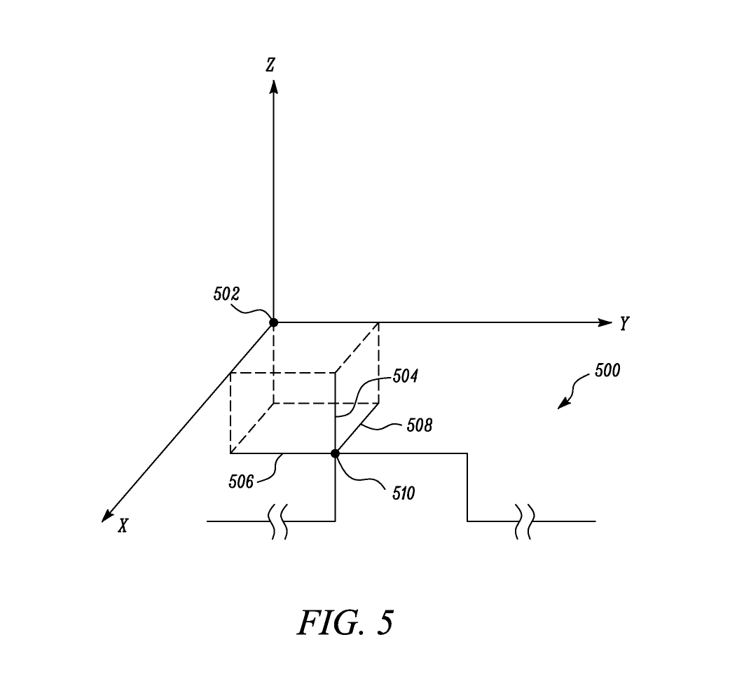

The system 100 may further include a service station 120. The service station 120 may be communicably coupled to the processing device 124. The service station 120 may be configured to determine a position of the conduit 104 relative to a predefined reference frame 502 (shown in FIG. 5) fixed with the service station 120. The service station 120 may be detachably connected to the processing device 124 via a cable 127. Alternatively, the service station 120 may be wirelessly connected to the processing device 124. The service station 120 may include an input module configured to receive signals from the processing device 124. The service station 120 may further include a memory module configured to store data received from the processing device 124. The memory module may also store information related to the underground utility 102. Further, the service station 120 may include a process module configured to process the signals received by the input module. The service station 120 may also include a position module configured to determine a position of the service station 120. In an embodiment, the position module may determine the position of the service station 120 with reference to a satellite based system such as Global Positioning System (GPS) 128. The process module may determine the predefined reference frame 502 (shown in FIG. 5) with the position of the service station 120 as a reference point. Specifically, the position module of the service station 120 may be configured to communicate electronic signals with the satellite based system 128 to the position of the service station 120. Thus, the predefined reference frame 502 may be determined with respect to the service station 120. Further, the service station 120 may include a display module configured to display various inputs and/or outputs of the service station 120. Additionally, the service station 120 may include an output module configured to communicate with a central server. The central server may receive and store various outputs of the service station 120 for storage and/or further processing. In an embodiment, the service station 120 may be a portable electronic device. The portable electronic device may include one of a laptop, a smartphone and a Personal Computer (PC).

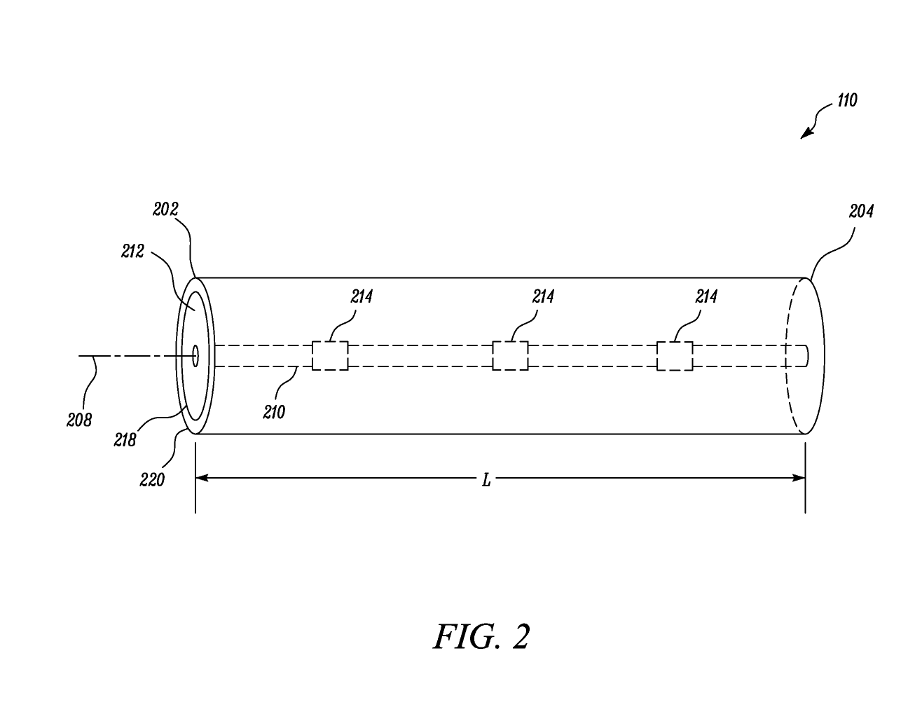

FIG. 2 illustrates a sectional perspective view of the fiber optic cable 110, according to an embodiment of the present disclosure. The fiber optic cable 110 may extend between a first end 202 and a second end 204 defining a length ‘L’. The fiber optic cable 110 may include an axis 208 along the length ‘L’ thereof. The fiber optic cable 110 may further include at least one core 210 that may extend between the first end 202 and the second end 204 of the fiber optic cable 110. The core 210 may pass through center of the fiber optic cable 110 and is configured to be a light-carrying element. Although the fiber optic cable 110, in the illustrated embodiment, includes one core 210, it may be contemplated that the system 100 may include a fiber optic cable having multiple cores.

The core 210 may be further surrounded by a layer of cladding 212. A material of the core 210 and the cladding 212 may be a polymer, such as polystyrene, PMMA, or the like known in the art. The material used for making the core 210 may have a high transparency and the material used for the cladding 212 may have a refractive index lower than the material of the cores 210. A difference between the refractive indices between the core 210 and the cladding 212 may provide total internal reflection of light to be transmitted within the core 210.

The fiber optic cable 110 may further include a plurality of strain sensors 214 distributed along a length of the core 210. Each of the plurality of strain sensors 214 may be disposed in the core 210 such that a distance between every adjacent strain sensors 214 may be kept substantially equal. Each of the strain sensors 214 may be, for example, a Fiber Bragg Gratings (FBGs) or a Rayleigh Scatter Detector. The strain sensors 214 may be further configured to estimate bending and/or twisting of the fiber optic cable 110 at each location of the strain sensor 214. Further, the strain sensors 214 may be configured to communicate with the processing device 124. More specifically, the receiver of the processing device 124 may be configured to selectively receive optical signal corresponding to each of the strain sensors 214. Further, the transmitter of the processing device 124 may be configured to send optical signal to the fiber optic cable 110 in order to receive feedback from the strain sensors 214.

Further, a layer 218 made from a polymer may be bonded to the cladding 212. The layer 218 may act as a protective coating. More specifically, the layer 218 may act as shock absorber to protect the core 210 and the cladding 212 from damage. The layer 218 may be further surrounded by a sleeve 220 that may be made from a reinforcing polymeric material, such as aramid. Specifically, the sleeve 220 may surround the cladding 212 along the length ‘L’ of the fiber optic cable 110. In an embodiment, an outer surface of the layer 218 and an inner surface of the sleeve 220 may not be bonded, adhered, or otherwise attached each other. Hence, the cladding 212 and the core 210 may rotate freely or twist within the sleeve 220 with minimal or no friction. In another embodiment, the sleeve 220 may be bonded to the layer 218.

The fiber optic cable 110, shown in FIG. 2, may be exemplary and should not be treated as a limitation to the scope of the present disclosure. It may also be contemplated that the system 100 may include a fiber optic cable assembly having multiple fiber optic cables received within a jacket. The multiple fiber optic cables may be connected to the service port 122 and hence, to the processing device 124.

FIG. 3 illustrates a partial sectional view of the conduit 104 having the fiber optic cable 110 coupled therewith, according to an embodiment of the present disclosure. The conduit 104 may include a wall 112 defining a passage 130 therein. Further, the conduit 104 may have a shape substantially cylindrical. The wall 112 may include an inner surface 132 and an outer surface 114. The passage 130 of the conduit 104 may be defined by the inner surface 132 of the wall 112. Further, the wall 112 includes a first end 134 and a second end 136 distal from the first end 134 along a longitudinal axis X-X′. The fiber optic cable 110 may be embedded within the wall 112 of the conduit 104. Specifically, the wall 112 may define a channel 135 positioned between the inner and outer surfaces 132, 114 to receive the fiber optic cable 110. The channel 135 may be formed during manufacture of the conduit 104. Alternatively, the channel 135 may be machined in the wall 112 after manufacture of the conduit 104. The fiber optic cable 110 may be longitudinally disposed within the channel 135 of the wall 112 such that the fiber optic cable 110 may extend between the first and second ends 134, 136 of the wall 112. The fiber optic cable 110 may further include a first end 137 and a second end 138. The first end 137 and the second end 138 may be configured to project outside from the first and second ends 134, 136 of the wall 112, respectively.

The conduit 104 may further include a coupling member 140 disposed adjacent to at least one of the first end 134 and the second end 136 of the wall 112. The coupling member 140 may be configured to detachably couple the conduit 104 to another conduit 104 disposed adjacent to the conduit 104. In the illustrated embodiment, the coupling member 140 may be shown coupled to the conduit 104 adjacent to the second end 136.

In the embodiment of FIG. 3, the coupling member 140 may be a press-fit coupler. The coupling member 140 may include a wall 141 having an outer surface 142 and an inner surface 144. Further, the coupling member 140 may include a coupling portion 143 configured to engage with the wall 112 of the conduit 104. A diameter of the inner surface 144 at the coupling portion 143 may be smaller than a diameter of the outer surface 114 of the wall 112 in order to achieve a press-fit therebetween. The another conduit 104 may be similarly connected to the coupling member 140. The inner surface 144 may define a passage in alignment with the passage 130 of the wall 112. The coupling member 140 may further include a hole 146 provided longitudinally in the wall 141. The hole 146 may be configured to align with the channel 135 when the coupling member 140 is coupled to the first and second ends 134, 136 of the conduit 104. The hole 146 may be further configured to receive the first end 137 or the second end 138 of the fiber optic cable 110 therethrough.

The fiber optic cable 110 may further include a connector 148 at one of the first end 137 and the second end 138. The connector 148 may be configured to couple the fiber optic cable 110 to another fiber optic cable 110. The another fiber optic cable 110 may be disposed in the another conduit 104 disposed adjacent to the conduit 104. In the embodiment of FIG. 3, the connector 148 may be at least one of a snap-fit connector and a threaded connector. In a further embodiment, the fiber optic cable 110 may extend into the ground 106 and connected to the service port 122 disposed vertically above the conduit 104. In such a case, a protective cover may be provided around the fiber optic cable 110 for protection against surrounding soil, moisture, deformation, and the like.

FIG. 4 is a partial sectional view of a conduit 404 coupled with the fiber optic cable 110, according to another embodiment of the present disclosure. The fiber optic cable 110 may be partially received in a channel 435 defined in a wall 412. Further, the first end 137 and the second end 138 of the fiber optic cable 110 may project out of the wall 412 from an outer surface 414 adjacent to a first end 434 and a second end 436 thereof. Further, the connector 148 may be connected to both the first end 137 and the second end 138 of the fiber optic cable 110.

The conduit 404 may further include a coupling member 440 disposed adjacent to at least one of the first end 434 and the second end 436 of the wall 412. In the embodiment of FIG. 4, the coupling member 440 may be a threaded coupler. The coupling member 440 coupled to the second end 436 of the wall 412 is considered herein below for detailed illustration of the present disclosure. The coupling member 440 includes a wall 441 having an inner surface 444 and an outer surface 442. The coupling member 440 further includes a coupling portion 443 configured to threadingly engage with the outer surface 414 of the wall 412. More specifically, the inner surface 444 at the coupling portion 443 may be provided with inner threads to engage with corresponding external threads provided on the outer surface 414 of the wall 412. The inner surface 444 may also define a passage in alignment with a passage 430 of the wall 412.

In an embodiment, a portion 445 of the fiber optic cable 110 projecting out of the conduit 404 may be aligned with the outer surface 442 of the coupling member 440 and coupled therewith. Further, the portion 445 of the fiber optic cable 110 projecting out of the conduit 104 may be secured to the outer surface 442 of the coupling member 440 by various methods, such as clamping.

FIG. 5 shows an output 500 of the system 100 showing a location of the underground utility 102, according to an embodiment of the present disclosure. The display module of the service station 120 may display the output 500 to the operator. The processing device 124 may be connected to the service port 122 to receive an output from the fiber optic cable 110 based on the signals generated by the strain sensors 214. The service station 120 may be further coupled to the processing device 124 to receive an output therefrom. Upon receipt of the output from the processing device 124, the process module may determine a position of the strain sensor 214 located nearest to the service station 120 that may be computed as a first position point 510 of the fiber optic cable 110. The first position point 510 of the fiber optic cable 110 may correspond to a position of the conduit 104 nearest to the service station 120. The process module may further compute locations of the subsequent strain sensors 214 with respect to the first position point 510 based on the signals received from the respective strain sensors 214. Further, the process module of the service station 120 may determine a position of the underground utility 102 with respect to the predefined reference frame 502. The predefined reference frame 502 fixed with the service station may be further determined by the positon module based on the GPS system 128. In the illustrated embodiment, the output 500 may show the underground utility 102 with respect to the position of the service station 120 as the reference point. The output 500 may further show the location of the underground utility 102 in a Cartesian coordinate system having X, Y and Z axes. In an exemplary graphical representation, a plane defined by X and Y axes of the Cartesian coordinate system may represent a surface of the ground 106. A distance 504 along Z axis may represent a distance of the conduit 104 below the ground 106. Further, the position of the first position point 510 from X-Z plane and Y-Z plane may be represented by distances 506 and 508, respectively. Therefore, the distances 504, 506 and 508 may represent a position of the first point 510 relative to the predefined reference frame 502. The Cartesian coordinate system may have a predefined scale, for example, a single unit along any of the axes may correspond to one meter. The reference point for the location of the underground utility 102 may be considered as an origin of the X, Y and Z axes.

As shown in FIG. 5, various conduits 104 of the underground utility 102 may be mapped in the output 500 and displayed along the X, Y and Z axes. Thus, positions of the various conduits 104 with reference to the service station 120 may be determined. It may be contemplated that the output 500 may provide a partial mapping of the underground utility 102 based on various requirements. In such cases, the fiber optic cables 110 may be provided on a selected number of conduits 104 which may be of interest.

The output 500 may additionally display information about angular orientation of various conduits 104. For example, if one of the conduits 104 is angularly displaced with respect to the adjacent conduits 104, the corresponding fiber optic cable 110 may also be angularly displaced relative to the adjacent fiber optic cables 110. Such angular data may also be displayed to provide an accurate position of the conduits 104.

### INDUSTRIAL APPLICABILITY

The present disclosure relates to the system 100 and the method 600 of locating the underground utility 102 having the conduit 104. At step 602, the method may include communicating the processing device 124 with the fiber optic cable 110. The processing device 124 may be configured to receive signals from the fiber optic cable 110 embedded within the wall 112, 412 of the conduit 104. The fiber optic cable 110 may be communicably coupled with the service port 122. Further, the cable 126 may be detachably coupled between the service port 122 and the processing device 124. The transmitter and the receiver of the processing device 124 may be in communication with the fiber optic cable 110 via the cable 126 and the service port 122.

At step 604, the method 600 may include communicating the service station 120 to the processing device 124. The cable 127 may be detachably coupled between the processing device 124 and the service station 120. Thus, the service station 120 may be communicably coupled with the fiber optic cable 110 to receive signals from the strain sensors 214. Specifically, the input module of the service station 120 may be in communication with the processing device 124.

At step 606, the method 600 may include receiving signals from the fiber optic cable 110 via the processing device 124. The transmitter of the processing device 124 may send an optical signal to the fiber optic cable 110 via the cable 126 and the service port 122. The receiver of the processing device 124 may receive signals from the plurality strain sensors 214 disposed in the fiber optic cable 110. Each of the strain sensors 214 may provide a signal indicative of a strain of a corresponding location of the fiber optic cable 110 upon receipt of the optical signal from the processing device 124. The strain of each of the strain sensors 214 may correspond to bending and/or twisting of the fiber optic cable 110 at the respective location. Further, the strain sensors 214 may provide bending and/or twisting of the corresponding locations of the fiber optic cable 110 along multiple planes.

At step 608, the method 600 may include determining the shape of the fiber optic cable based on the signals received from the plurality of strain sensors. A position of one of the strain sensors 214 may be computed in the Cartesian coordinate system. In an embodiment, the position of the strain sensor 214 located nearest to the service station 120 may be computed as a first position point 510 of the fiber optic cable 110. The process module may further compute locations of the subsequent strain sensors 214 with respect to the first position point 510 based on the signals received from the respective strain sensors 214. Thus, the process module may determine the positions of various points along the length of the fiber optic cable 110.

In an embodiment, a segment of the fiber optic cable 110 may be defined as a portion of the core 210 between two adjacent strain sensors 214. The position of each of the segments may be determined based on the strain data received from the corresponding strain sensors 214 and comparing the data with adjoining segments. The data for each of the segments may be combined to determine the position, shape and orientation of the fiber optic cable 110.

At step 610, the method 600 may include determining a position of the conduit 104 relative to the predefined reference frame 502 fixed with the service station 120 based on the shape of the fiber optic cable 110. The position module may determine the GPS position of the service station 120. The predefined reference frame 502 may be based on the GPS position of the service station 120. Further, the position of the service station 120 may be the origin of the Cartesian coordinate system shown in FIG. 5. In an embodiment, the first position point 510 of the fiber optic cable 110 may be located nearest to the service station 120. Further, the first position point 510 may correspond to a position of the conduit 104 nearest to the service station 120. The process module may further determine locations of the conduit 104 based on the shape and orientation of the fiber optic cable 110. Thus, the process module may determine the positions of various points along the length of the fiber optic cable 110, and hence the conduit 104 with respect to the predefined reference frame 502. In an embodiment, information related to dimensions and/or shape of the various conduits 104 of the underground utility 102 may be stored within the memory module of the service station 120. The process module may compute a virtual three dimensional representation of the underground utility 102 as the output 500 based on the signals received from the strains sensors 214 and the stored information. An operator may be able manipulate the three dimensional representation of the underground utility 102 in various manners, for example, rotate, pan, zooming in and out etc.

The system 100 and the method 600 may enable determination of the position of the conduit 104 relative the predefined reference frame 502 from above the ground 106. Therefore, when an operation, for example, construction or excavation, may have to be performed on the ground above the underground utility 102, the exact position of the conduit 104 may prevent accidental damage to the conduit 104. Further, the position of the conduits 104 may facilitate maintenance of the underground utility 102. For example, a displacement or misalignment of one or more conduits 104 may be detected from above ground. Further, information for carrying out any modifications to an existing underground utility may be conveniently obtained from ground 106.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

What is claimed is:

1. A system for locating an underground utility having a conduit, the system comprising:
a fiber optic cable coupled to the conduit, the fiber optic cable comprising at least one core and a plurality of strain sensors distributed along a length of the at least one core;
a processing device disposed in selective communication with the fiber optic cable, the processing device configured to receive signals from the plurality of strain sensors; and
a service station communicably coupled to the processing device, wherein the service station configured to determine a shape of the fiber optic cable, and wherein the service station further configured to determine a position of the conduit relative to a predefined reference frame fixed with the service station based on the shape of the fiber optic cable.

2. The system of claim 1, wherein at least a portion of the fiber optic cable is embedded within a wall of the conduit.

3. The system of claim 1, wherein each of the plurality of strain sensors is one of a Fiber Bragg Grating (FBG) sensor and Rayleigh Scatter Detector.

4. The system of claim 1, wherein the predefined reference frame is a Global Positioning System (GPS) location of the service station.

5. The system of claim 1, further comprising a service port coupled to the fiber optic cable, the service port accessible from above ground and configured to be communicably coupled to the processing device.

6. The system of claim 1, the fiber optic cable comprising a connector at an end thereof, wherein the connector is configured to couple the fiber optic cable to another fiber optic cable, and wherein the another fiber optic cable is coupled to another conduit disposed adjacent to the conduit.

7. The system of claim 1, wherein the processing device is further configured to send an optical signal to the fiber optic cable.

8. The system of claim 1, wherein the service station comprising a portable electronic device.

9. The system of claim 8, wherein the portable electronic device is one of a laptop, a smartphone and a Personal Computer (PC).

10. A conduit for an underground utility, the conduit comprising:
a wall defining a passage therein, the wall having a first end and a second end;
a fiber optic cable embedded within the wall, the fiber optic cable comprising at least one core and a plurality of strain sensors distributed along a length of the at least one core; and
a coupling member disposed adjacent to at least one of the first end and the second end, the coupling member configured to detachably couple the conduit to another conduit disposed adjacent to the conduit.

11. The conduit of claim 10, the fiber optic cable comprising a connector at an end thereof, wherein the connector is configured to couple the fiber optic cable to another fiber optic cable, and wherein the another fiber optic cable is coupled to the another conduit disposed adjacent to the conduit.

12. The conduit of claim 11, wherein the connector is one of a threaded connector and a snap-fit connector.

13. The conduit of claim 10, wherein each of the plurality of strain sensors is a Fiber Bragg Grating (FBG) sensor and Rayleigh Scatter Detector.

14. The conduit of claim 10, wherein the coupling member is one of a threaded coupler and a press-fit coupler.

15. The conduit of claim 10, wherein the fiber optic cable is embedded within the coupling member.

16. The conduit of claim 10, wherein ends of the fiber optic cable projects outside from at least one of the first end and the second end of the wall of the conduit proximate to the coupling member.

17. A method of locating an underground utility having a conduit, the method comprising:
communicating a processing device with a fiber optic cable, wherein the processing device is configured to receive signals from the fiber optic cable;
communicating a service station with the processing device;
receiving signals via the processing device from a plurality of strain sensors, wherein the plurality of strain sensors are distributed along a length of at least one core of the fiber optic cable;
determining a shape of the fiber optic cable based on the signals received from the plurality of strain sensors; and
determining a position of the conduit relative to a predefined reference frame fixed with the service station based on the shape of the fiber optic cable.

18. The method of claim 17, wherein the predefined reference frame is a Global Positioning System (GPS) location of the service station.

19. The method of claim 17, further comprising sending an optical signal via the processing device to the fiber optic cable.

20. The method of claim 17, further comprising coupling the processing device to a service port accessible from above ground, wherein the service port is communicably coupled to the fiber optic cable.
